(19) United States
(12) Patent Application Publication
(10) Pub. No.: US 2011/0137805 A1
(43) Pub. Date: Jun. 9, 2011

(54) INTER-CLOUD RESOURCE SHARING WITHIN A CLOUD COMPUTING ENVIRONMENT

(75) Inventors: Michael D. Brookbanks, Nyelimber (GB); Brendan F. Coffey, Rhinebeck, NY (US); Christopher J. Dawson, Arlington, VA (US); Thirumal Nellutla, Schaumburg, IL (US); Robert C. Patterson, JR., Sewickley, PA (US); James W. Seaman, Falls Church, VA (US)

(73) Assignee: International Business Machines Corporation, Armonk, NY (US)

(21) Appl. No.: 12/630,079

(22) Filed: Dec. 3, 2009

(51) Int. Cl. G06F 15/173; G06Q 10/00; G06Q 30/00; G06Q 20/00; G06Q 50/00

(52) U.S. Cl. 705/80; 709/226; 705/301

(57) ABSTRACT

The present invention provides a system and method for establishing inter-Cloud resource sharing agreements and policies such that dynamic expansion/contraction of Cloud resource requests can be seamlessly addressed without requiring physical build-out of the primary Cloud infrastructure and advertising the need for additional resources or the offer to provide additional resources can be brokered through an established marketplace. The financial transaction will support a symbiotic bi-lateral fair-share method that better aligns with an alternating supplier/consumer business model. Using this system and method will decrease the amount of time needed to respond to a given Cloud service request while advantaging a resource sharing model amongst established Cloud providers.

### CROSS-REFERENCE TO RELATED APPLICATION

This application is related in some aspects to pending application number (to be provided) having the title “CREDIT MANAGEMENT FOR RESOURCE SHARING WITHIN A CLOUD COMPUTING ENVIRONMENT”, filed on (to be provided), having attorney docket number END920090109US1, the entire contents of which are herein incorporated by reference.

### FIELD OF THE INVENTION

In general, the present invention relates to Cloud computing. Specifically, the present invention relates to inter-Cloud resource sharing within a Cloud computing environment.

### BACKGROUND OF THE INVENTION

Cloud computing has become a popular way to offer various Information Technology (IT) concepts as services. In one implementation, a consumer or requestor can request a service they desire and transact with a Cloud provider for the needed service. A Cloud provider's business opportunity can be limited or constrained by the physical resources they have installed or by their capacity to procure additional resources in a timely and cost-efficient manner. In many cases, if the customer (service requestor) has not allowed for ample lead time, then the request likely is not fulfilled by the Cloud provider or is not fulfilled in a timely manner.

### SUMMARY OF THE INVENTION

This disclosure describes a system and method for establishing inter-Cloud resource sharing agreements and policies such that dynamic expansion/contraction of Cloud resource requests can be seamlessly addressed without requiring physical build-out of the primary Cloud infrastructure and advertising the need for additional resources or the offer to provide additional resources can be brokered through an established marketplace. The financial transaction will support a symbiotic bi-lateral fair-share method that better aligns with an alternating supplier/consumer business model. Using this system and method will significantly decrease the amount of time needed to respond to a given Cloud service request while advantaging a resource sharing model amongst established Cloud providers.

Among other things, the present invention allows for Cloud providers to: advertise their resource requirements amongst an established marketplace; offer their resources to satisfy an existing Cloud provider request; and/or utilize a ‘fair-sharing’ method that manages how resource requests are financed.

A first aspect of the present invention provides a method for inter-Cloud resource sharing in a Cloud computing environment, comprising: assessing a resource requirement needed to fulfill a request received on a first Cloud provider; determining whether the first Cloud provider has resources available to meet the resource requirement; identifying a second Cloud provider capable of fulfilling any shortfall between the resources available for the first Cloud provider and the resource requirement; and negotiating between the first Cloud provider and the second Cloud provider to fulfill the shortfall using resources of the second Cloud provider.

A second aspect of the present invention provides a Cloud manager for managing inter-Cloud resource sharing in a Cloud computing environment, comprising; a memory medium comprising instructions; a bus coupled to the memory medium; and a processor coupled to the bus that when executing the instructions causes the Cloud manager to: assess a resource requirement needed to fulfill a request received on a first Cloud provider; determine whether the first Cloud provider has resources available to meet the resource requirement; identify a second Cloud provider capable of fulfilling any shortfall between the resources available for the first Cloud provider and the resource requirement; and negotiate between the first Cloud provider and the second Cloud provider to fulfill the shortfall using resources of the second Cloud provider.

A third aspect of the present invention provides a computer readable medium containing a program product for managing inter-Cloud resource sharing in a Cloud computing environment, the computer readable medium comprising program code for causing a computer system to: assess a resource requirement needed to fulfill a request received on a first Cloud provider; determine whether the first Cloud provider has resources available to meet the resource requirement; identify a second Cloud provider capable of fulfilling any shortfall between the resources available for the first Cloud provider and the resource requirement; and negotiate between the first Cloud provider and the second Cloud provider to fulfill the shortfall using resources of the second Cloud provider.

A fourth aspect of the present invention provides a method for deploying a system for managing inter-Cloud resource sharing in a Cloud computing environment, comprising: providing a computer infrastructure being operable to: assess a resource requirement needed to fulfill a request received on a first Cloud provider; determine whether the first Cloud provider has resources available to meet the resource requirement; identify a second Cloud provider capable of fulfilling any shortfall between the resources available for the first Cloud provider and the resource requirement; and negotiate between the first Cloud provider and the second Cloud provider to fulfill the shortfall using resources of the second Cloud provider.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a Cloud system node according to the present invention.

FIG. 2 shows a Cloud computing environment according to the present invention.

FIG. 3 shows Cloud abstraction model layers according to the present invention.

FIG. 4 shows an illustrative example of inter-Cloud resource sharing according to the present invention.

FIG. 5 shows an illustrative example of how service consumers are accessing services with a primary Cloud provider according to the present invention.

FIG. 6 shows an illustrative example of Cloud transaction tracking pursuant to the example of FIGS. 4-5 according to the present invention.

FIG. 7 shows a flow diagram of a method according the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:

I. Cloud Computing Definitions

II. Detailed Implementation of the Invention

### I. Cloud Computing Definitions

The following definitions have been derived from the “Draft NIST Working Definition of Cloud Computing” by Peter Mell and Tim Grance, dated Oct. 7, 2009, which is cited on an IDS filed herewith, and a copy of which is attached thereto.

“Cloud computing” is a model for enabling convenient, on-demand network access to a shared pool of configurable computing resources (e.g., networks, servers, storage, applications, and services) that can be rapidly provisioned and released with minimal management effort or service provider interaction. This cloud model promotes availability and is comprised of at least five characteristics, three service models, and four deployment models. Characteristics are as follows:

On-demand self-service: A consumer can unilaterally provision computing capabilities, such as server time and network storage, as needed automatically without requiring human interaction with each service's provider. Broad network access: Capabilities are available over the network and accessed through standard mechanisms that promote use by heterogeneous thin or thick client platforms (e.g., mobile phones, laptops, and PDAs).

Resource pooling: The provider's computing resources are pooled to serve multiple consumers using a multi-tenant model, with different physical and virtual resources dynamically assigned and reassigned according to consumer demand. There is a sense of location independence in that the customer generally has no control or knowledge over the exact location of the provided resources but may be able to specify location at a higher level of abstraction (e.g., country, state, or datacenter). Examples of resources include storage, processing, memory, network bandwidth, and virtual machines.

Rapid elasticity: Capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured Service: Cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Cloud Software as a Service (SaaS): The capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Cloud Platform as a Service (PaaS): The capability provided to the consumer is to deploy onto the cloud infrastructure consumer-created or acquired applications created using programming languages and tools supported by the provider. The consumer does not manage or control the underlying cloud infrastructure including network, servers, operating systems, or storage, but has control over the deployed applications and possibly application hosting environment configurations.

Cloud Infrastructure as a Service (IaaS): The capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: The cloud infrastructure is operated solely for an organization. It may be managed by the organization or a third party and may exist on premise or off premise.

Community cloud: The cloud infrastructure is shared by several organizations and supports a specific community that has shared concerns (e.g., mission, security requirements, policy, and compliance considerations). It may be managed by the organizations or a third party and may exist on premise or off premise.

Public cloud: The cloud infrastructure is made available to the general public or a large industry group and is owned by an organization selling cloud services.

Hybrid cloud: The cloud infrastructure is a composition of two or more clouds (private, community, or public) that remain unique entities but are bound together by standardized or proprietary technology that enables data and application portability (e.g., cloud bursting for load-balancing between clouds).

Cloud software takes full advantage of the cloud paradigm by being service oriented with a focus on statelessness, low coupling, modularity, and semantic interoperability.

II. Implementation of the Present invention

As indicated above, this disclosure describes a system and method for establishing inter-Cloud resource sharing agreements and policies such that dynamic expansion/contraction of Cloud resource requests can be seamlessly addressed without requiring physical build-out of the primary Cloud infrastructure and advertising the need for additional resources, or the offer to provide additional resources can be brokered through an established marketplace. The financial transaction will support a symbiotic bi-lateral fair-share method that better aligns with an alternating supplier/consumer business model. Using this system and method will significantly decrease the amount of time needed to respond to a given Cloud service request while advantaging a resource sharing model amongst established Cloud providers. Among other things, the present invention allows for Cloud providers to: advertise their resource requirements amongst an established marketplace; offer their resources to satisfy an existing Cloud provider request; and/or utilize a ‘fair-sharing’ method that manages how resource requests are financed.

One value to Cloud providers is that they are able to optimize use of their resources, by either offering them to other Cloud providers who have expressed a need or by requesting them from Cloud providers who are offering them for use. This allows Cloud providers a cost-effective mechanism to dynamically expand the capacity of their Cloud infrastructure without expending capital to procure new Cloud assets for temporary demands. They avoid large capital outlays that perhaps don't justify themselves and they are able to positively respond to a higher percentage of their customer's service requests. Additionally, the ‘cost-neutral’ algorithm will seek to optimize the outgoing Cloud provider demand-requests with outgoing Cloud provider supply-requests across the Cloud providers participating in the business network, thus seeking to further reduce capital and expense outlays.

Today, Cloud providers exist in singular domains and are focusing on providing a given resource, such as access to computers, computer storage, business applications, etc. To provide these Cloud capabilities to its customers, the Cloud providers need to invest money, time, and energy in building out their IT infrastructure to meet the expected demands from its clients. If they over-build, they diminish their return on capital investment and if they under-build, they lose the opportunity to capture growth. Being able to meet the demands that emerge without comprising the return on their capital investments will help them become profitable enterprises. To be able to execute on this approach requires a system and method for obtaining access to the required amount of Cloud resources from beyond the primary established Cloud infrastructure.

This is accomplished through a broadcast mechanism that describes the availability of resources as well as the need for resources across an established marketplace of participating Cloud providers, and through an algorithm that manages the transactions between each Cloud provider via a token-based method where the number of outstanding tokens with any given provider will influence future transaction-to-member selection. A billing sweep mechanism will be invoked at specified intervals to resolve outstanding balances that have not reached the cost-neutral target through normal token transactions. Overall, this invention provides a novel way for efficiently satisfying dynamic resource demands that occur within a Cloud environment, arranging for a ‘fair-sharing’ method for accomplishing Cloud-to-Cloud transactions, and diminishing the need for short-term capital infrastructure costs.

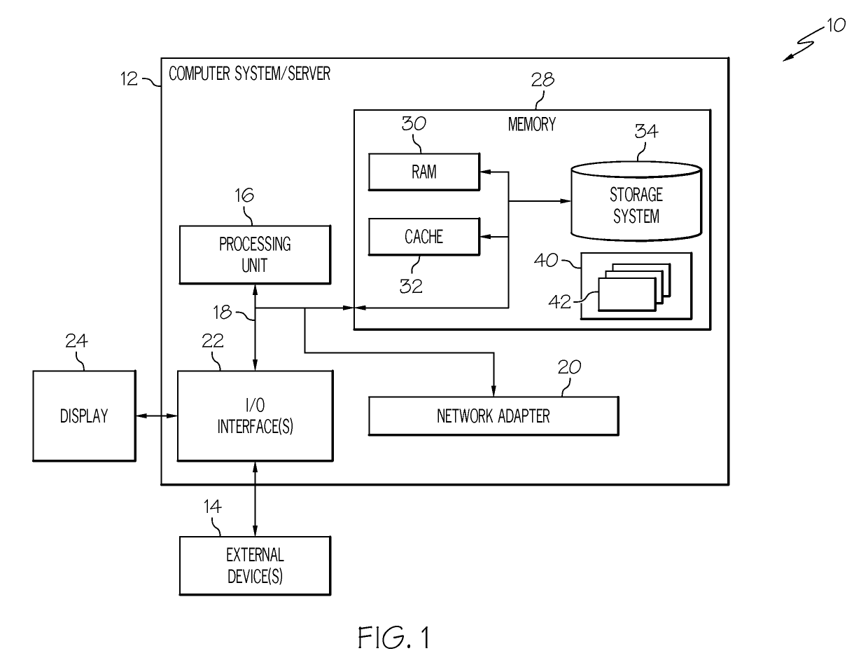

Referring now to FIG. 1, a schematic of an exemplary cloud computing node is shown. Cloud computing node 10 is only one example of a suitable cloud computing node and is not intended to suggest any limitation as to the scope of use or functionality of the invention described herein. Regardless, cloud computing node 10 is capable of being implemented and/or performing any of the functions set forth in section I above.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules include routines, programs, objects, components, logic, data structures, and so on that perform particular tasks or implement particular abstract data types. The exemplary computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, a storage system 34 can be provided for reading from and writing to a non-removable, non-volatile magnetic media (not shown and typically called a “hard drive”). Although not shown a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of the invention.

Program/utility 40 having a set (at least one) of program modules 42 may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

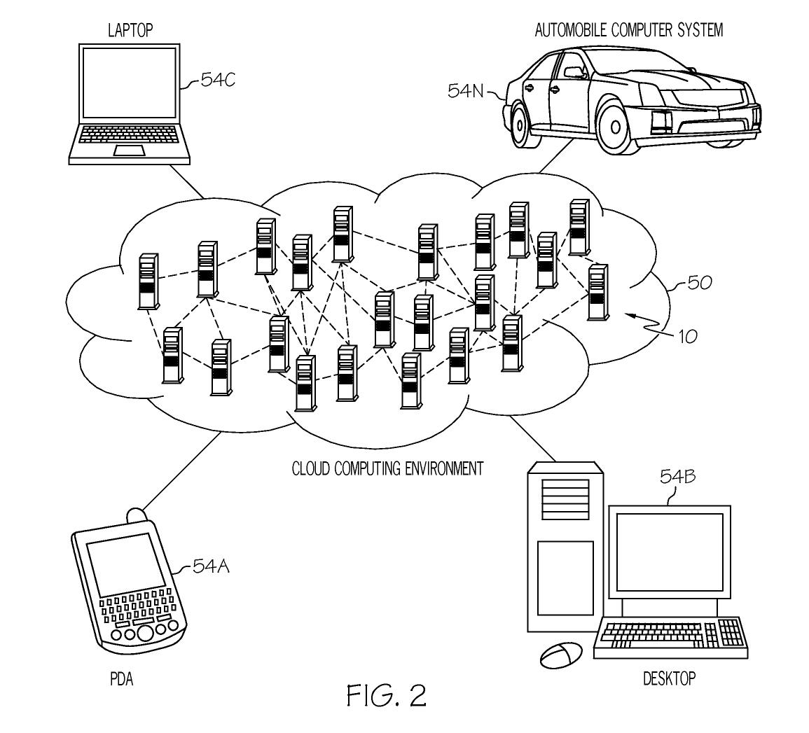

Referring now to FIG. 2, illustrative cloud computing environment 50 is depicted. As shown, cloud computing environment 50 comprises one or more cloud computing nodes 10 with which computing devices such as, for example, personal digital assistant (PDA) or cellular telephone 54A, desktop computer 54B, laptop computer 54C, and/or automobile computer system 54N communicate. This allows for infrastructure, platforms and/or software to be offered as services (as described above in Section I) from cloud computing environment 50 so as to not require each client to separately maintain such resources. It is understood that the types of computing devices 54A-N shown in FIG. 2 are intended to be illustrative only and that cloud computing environment 50 can communicate with any type of computerized device over any type of network and/or network/addressable connection (e.g., using a web browser).

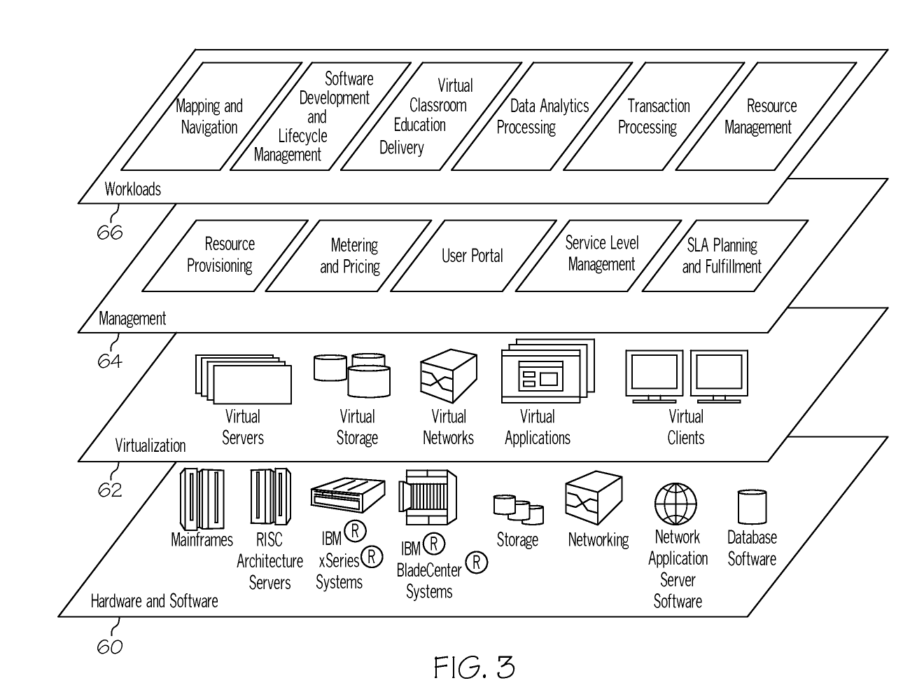

Referring now to FIG. 3, a set of functional abstraction layers provided by cloud computing environment 50 (FIG. 2) is shown. It should be understood in advance that the components, layers, and functions shown in FIG. 3 are intended to be illustrative only and the invention is not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation in the United States, other countries, or both.) Virtualization layer 62 provides an abstraction layer from which the following exemplary virtual entities may be provided: virtual servers; virtual storage; virtual networks, including virtual private networks; virtual applications; and virtual clients.

Management layer 64 provides the exemplary functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for users and tasks, as well as protection for data and other resources. User portal provides access to the cloud computing environment for both users and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides functionality for which the cloud computing environment is utilized. Examples of workloads and functions which may be provided from this layer include: mapping and navigation; software development and lifecycle management; virtual classroom education delivery; data analytics processing; transaction processing, and resource management.

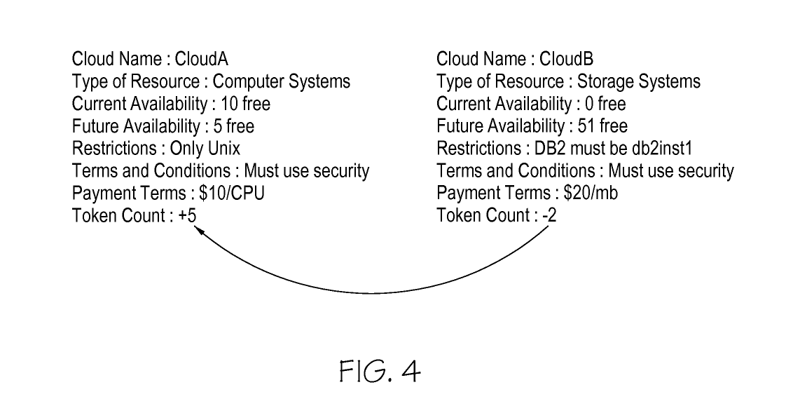

In general, resource management functionality implements the functions of the present invention as discussed herein in conjunction with FIGS. 4-7. As mentioned above, the present invention provides a web-based directory of Cloud providers who will broadcast the availability of their Cloud resources to other members of this private community. Participation in the community may be fee-based under one embodiment.

The directory will describe the types of resource, the amount of resource, the planned and current availability of the resource, any resource usage restrictions, and terms and conditions that will be applied (e.g., rate structure for $/terrabyte of storage per day/use). The payment terms will reflect agreed-upon values that a given member is willing to accept for use of their specific resources (e.g., $/terrabyte of storage per day/use is equivalent to 2 CPUs per day/use). A Transaction Engine will apply analytics against both the directory and specific transaction requests. The transactions will be represented through a token-based exchange system. Each member is allowed to view the directory entries but is not given visibility into resource transactions that they are not participants in.

Referring now to FIG. 4, these concepts will be explained in the context of two illustrative Clouds, namely, Cloud A and Cloud B. Specifically, the diagram shows an example section of the advertised services by the two Clouds. Consider the example that Cloud A receives a request for service that requires both computer systems and storage systems. In this case, further assume that Cloud A is not able to fully meet the requirements, as it has no capabilities to provide storage. A Cloud provider directory is used to find other Cloud providers within the private network that may be able to provide storage. Assume that multiple Cloud providers are found (one of which is Cloud B). Using a combination of both, alignment of needed requirements to (but not limited to) capability, price, and a prioritized list can be generated. A token count can also be taken into consideration. That is to say, a number or count could represent how ‘IN DEBT’ Cloud A is to the searched Cloud. In the example of FIG. 2, Cloud B may be in debt by −2. This means that Cloud B has used Cloud A two times, but not the other way around. Therefore Cloud B is chosen due to its debt to Cloud A. Based on a mathematical calculation, the token count may be deducted from Cloud B and added to Cloud A. In FIG. 4, the illustrative restrictions include the term Unix® which is a trademark of The Open Group the United States and other countries, and the term DB2® which is a trademark of IBM Corp. in the United States and/or other countries.

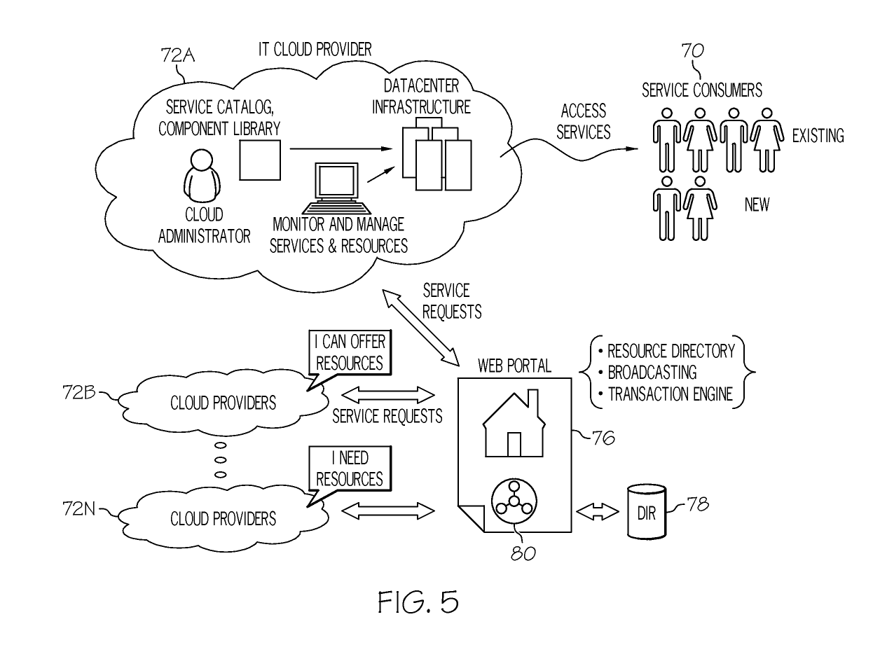

At the end of a period of time, a ‘true up’ may occur whereby pricing and other financial obligations calculated. The goal is to minimize financial transfer by ensuring fair sharing. In the example of FIG. 5, service consumers 70 are accessing services with a primary Cloud provider 72A. Cloud provider 72A can make service requests to the Cloud Community through the web portal or other medium 76. The portal 76 maintains the directory 78 of available resources and each resource's specific attributes (e.g., price, availability, type, etc). In addition, Cloud providers 72B-N can broadcast their resource needs or offers. A transaction engine 80 drives the analytic assessment of which provider is the ‘best fit’ for a given transaction.

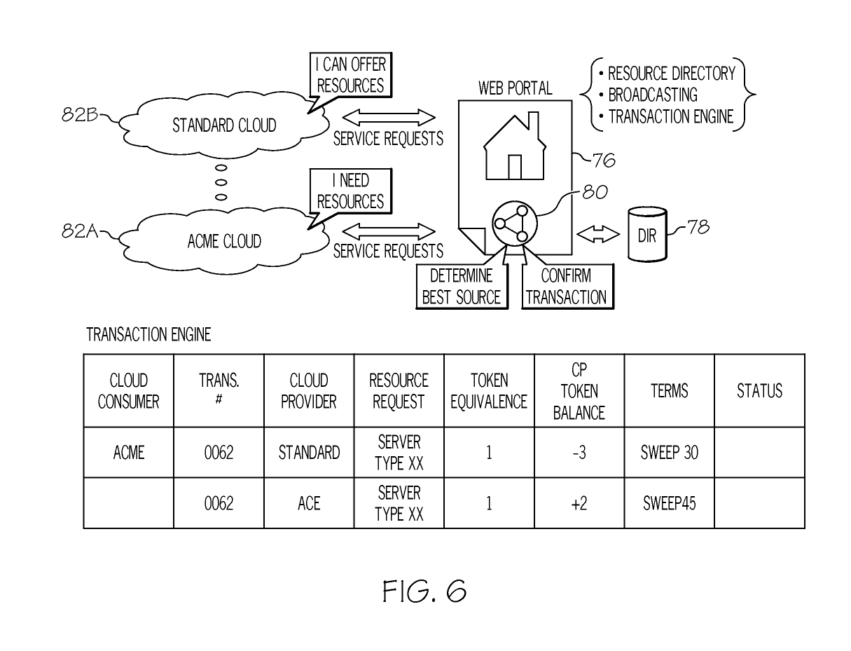

With an established membership of Cloud providers and their respective resources documented and available in the directory, Cloud members are available to query the directory on an as-needed basis. For example, referring to FIG. 6, if Acme Cloud provider 82A determines they have a need for additional computer servers to meet their client's needs, it can query directory 78 for available resources that meet their needs. If an agreement is reached on a transaction, in this example with Standard Cloud provider 82B, this information is captured in transaction engine 80. In general, transaction engine 80 implements an algorithm that will track transactions for each member, such that future transactions are optimized towards a cost-neutral objective. In this case, a token will have been assigned to Acme Cloud provider 82A representing that they have an outstanding balance with Standard Cloud provider 82B. In the example below, the transaction engine 80 has identified that at least two Cloud providers can meet Acme Cloud provider 82A′s resource request and it has also recognized that ‘Cloud Provider: Standard’ has a negative token balance with Acme Cloud provider 82B, whereas ‘Cloud Provider: Ace’ has a positive token balance. It is therefore to Acme's benefit to transact with Standard Cloud at this time vs. increasing the outstanding token balance it has with Ace. Transaction engine 80 will update the token balances between Acme and Standard and confirm the transaction. Should no further transactions occur between Acme and Standard before the pre-defined sweep cycle, Standard Cloud provider 82B would be obligated to satisfy its outstanding token debt (e.g., 2) with Acme Cloud provider 82A.

In an example, if Standard Cloud provider 82A has transacted six times to provide resources to Acme, and thus had six tokens outstanding with Acme Cloud provider 82B, then the transaction engine would suggest to Standard Cloud provider 82A that any future resource demands that they have be transacted with Acme Cloud provider 82B as a first priority. Similarly, if Standard Cloud provider 82A has transactions that provided resources to a given member, then future resource demands would be prioritized towards those members. Additional prioritization embedded in the transaction engine would include preferences for price, qualities of service, and service level agreements.

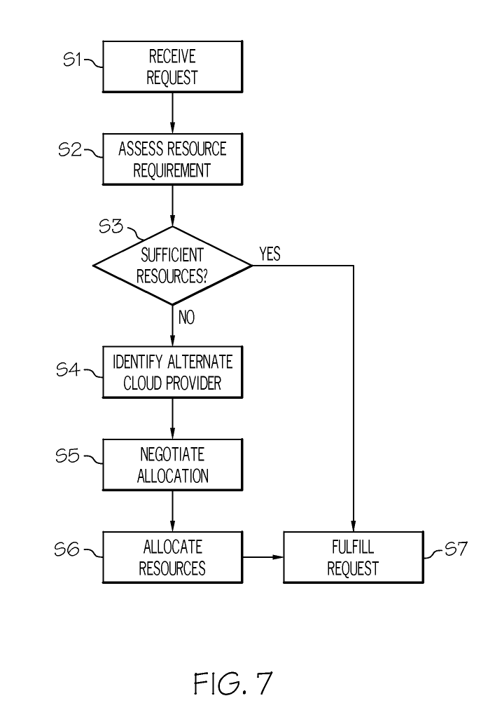

Referring now to FIG. 7, a method flow diagram according to the present invention is shown. As shown, in step S1, a request for Cloud services is received by a first Cloud provider. In step S2, a resource requirement needed to fulfill the request is assessed. In step S3, it is determined whether the first Cloud provider has resources available to meet the resource requirement. If so, the request is fulfilled in step S7. If not, a second Cloud provider capable of fulfilling any shortfall between the resources available for the first Cloud provider and the resource requirement is identified in step S4. In step S5, an allocation of resources is negotiated between the first Cloud provider and the second Cloud provider to fulfill the shortfall using resources of the second Cloud provider. In step S6, the needed/missing resources of the second Cloud provider are allocated to the first Cloud provider to address the shortfall so that the request can be fulfilled in step S7.

While shown and described herein as an inter-Cloud resource sharing/management solution, it is understood that the invention further provides various alternative embodiments. For example, in one embodiment, the invention provides a computer-readable/useable medium that includes computer program code to enable a computer infrastructure to provide inter-Cloud resource sharing/management functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a method that performs the process of the invention on a subscription, advertising, and/or fee basis. That is, a service provider, such as a Solution Integrator, could offer to provide inter-Cloud resource sharing/management functionality. In this case, the service provider can create, maintain, support, etc., a computer infrastructure, such as computer system 102 (FIG. 1) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for providing inter-Cloud resource sharing/management functionality. In this case, a computer infrastructure, such as computer system 102 (FIG. 1), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 102 (FIG. 1), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A method for inter-Cloud resource sharing in a Cloud computing environment, comprising:
assessing a resource requirement needed to fulfill a request received on a first Cloud provider;
determining whether the first Cloud provider has resources available to meet the resource requirement;
identifying a second Cloud provider capable of fulfilling any shortfall between the resources available for the first Cloud provider and the resource requirement; and
negotiating between the first Cloud provider and the second Cloud provider to fulfill the shortfall using resources of the second Cloud provider.

2. The method of claim 1, further comprising allocating the resources of the second Cloud provider to the first Cloud provider to address the shortfall based on a success of the negotiating.

3. The method of claim 1, the negotiating comprising negotiating an exchange of compensation between the first Cloud provider and the second Cloud provider for use of the resources of the second Cloud provider.

4. The method of claim 3, further comprising exchanging the compensation.

5. The method of claim 4, further comprising the exchanging comprising toggling token counts of the first Cloud provider and the second Cloud provider to reflect allocation of the resources of the second Cloud provider by the first Cloud provider.

6. The method of claim 1, the resource requirement comprising at least one of the following: storage space or processor availability.

7. The method of claim 1, the identifying comprising accessing a directory of Cloud providers, the directory associating Cloud providers with their available resources.

8. A Cloud manager for managing inter-Cloud resource sharing in a Cloud computing environment, comprising;
a memory medium comprising instructions;
a bus coupled to the memory medium; and
a processor coupled to the bus that when executing the instructions causes the Cloud manager to:
assess a resource requirement needed to fulfill a request received on a first Cloud provider;
determine whether the first Cloud provider has resources available to meet the resource requirement;
identify a second Cloud provider capable of fulfilling any shortfall between the resources available for the first Cloud provider and the resource requirement; and
negotiate between the first Cloud provider and the second Cloud provider to fulfill the shortfall using resources of the second Cloud provider.

9. The Cloud manager of claim 8, the Cloud manager being further caused to allocate the resources of the second Cloud provider to the first Cloud provider to address the shortfall based on a success of the negotiating.

10. The Cloud manager of claim 8, the Cloud manager being further caused to negotiate an exchange of compensation between the first Cloud provider and the second Cloud provider for use of the resources of the second Cloud provider.

11. The Cloud manager of claim 10, the Cloud manager being further caused to exchange the compensation.

12. The Cloud manager of claim 11, the Cloud manager being further caused to toggle token counts of the first Cloud provider and the second Cloud provider to reflect allocation of the resources of the second Cloud provider by the first Cloud provider.

13. The Cloud manager of claim 8, the resource requirement comprising at least one of the following: storage space or processor availability.

14. The Cloud manager of claim 8, the Cloud manager being further caused to access a directory of Cloud providers, the directory associating Cloud providers with their available resources.

15. A computer readable medium containing a program product for managing inter-Cloud resource sharing in a Cloud computing environment, the computer readable medium comprising program code for causing a computer system to:
assess a resource requirement needed to fulfill a request received on a first Cloud provider;
determine whether the first Cloud provider has resources available to meet the resource requirement;
identify a second Cloud provider capable of fulfilling any shortfall between the resources available for the first Cloud provider and the resource requirement; and
negotiate between the first Cloud provider and the second Cloud provider to fulfill the shortfall using resources of the second Cloud provider.

16. The computer readable medium containing the program product of claim 15, the computer readable medium further comprising program code for causing the computer system to allocate the resources of the second Cloud provider to the first Cloud provider to address the shortfall based on a success of the negotiating.

17. The computer readable medium containing the program product of claim 15, the computer readable medium further comprising program code for causing the computer system to negotiate an exchange of compensation between the first Cloud provider and the second Cloud provider for use of the resources of the second Cloud provider.

18. The computer readable medium containing the program product of claim 17, the computer readable medium further comprising program code for causing the computer system to exchange the compensation.

19. The computer readable medium containing the program product of claim 18, the computer readable medium further comprising program code for causing the computer system to toggle token counts of the first Cloud provider and the second Cloud provider to reflect allocation of the resources of the second Cloud provider by the first Cloud provider.

20. The computer readable medium containing the program product of claim 18, the resource requirement comprising at least one of the following: storage space, or processor availability.

21. The computer readable medium containing the program product of claim 17, the computer readable medium further comprising program code for causing the computer system to access a directory of Cloud providers, the directory associating Cloud providers with their available resources.

22. A method for deploying a system for managing inter-Cloud resource sharing in a Cloud computing environment, comprising:
providing a computer infrastructure being operable to:
assess a resource requirement needed to fulfill a request received on a first Cloud provider;
determine whether the first Cloud provider has resources available to meet the resource requirement;
identify a second Cloud provider capable of fulfilling any shortfall between the resources available for the first Cloud provider and the resource requirement; and
negotiate between the first Cloud provider and the second Cloud provider to fulfill the shortfall using resources of the second Cloud provider.
